(19) United States
(12) Patent Application Publication
(10) Pub. No.: US 2010/0217519 A1
(43) Pub. Date: Aug. 26, 2010

(54) METHOD AND NAVIGATION DEVICE FOR DETERMINING THE ESTIMATED TIME OF TRAVEL

(75) Inventors: Harald Englerth, Wurzburg (DE); Thorsten W. Schmidt, Kitzingen (DE); Feliu Ros, Wurzburg (DE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: NAVIGON AG, Hamburg (DE)

(21) Appl. No.: 12/712,642

(22) Filed: Feb. 25, 2010

(30) Foreign Application Priority Data
Feb. 26, 2009 (DE) 10 2009 010 381.3
Sep. 29, 2009 (DE) 10 2009 043 309.0

(51) Int. Cl. G01C 21/36

(52) U.S. Cl. 701/204

(57) ABSTRACT

The present invention relates to a method for determining the estimated time of travel and time of arrival in the route determination on a digital road map by means of a speed table and by means of measured user speeds. Moreover, the present invention relates to a corresponding computer program product and to a digital storage medium as well as to a corresponding navigation device.

The present invention is characterized by the feature that the speed table is classified into temporal classes (k, l, m, n) for at least one, preferably for each road category (B), wherein one temporal class is respectively allocated separate average speeds as a function of the weekday and/or the time of day (A).

By means of the present invention, the user-specific driving behavior in determining the estimated time of travel can be automatically taken into consideration by a navigation device and the estimated time of arrival of the user can be determined as a function of various, particularly temporal and/or geographic road attributes, with the degree of accuracy gradually increasing with increasing frequency of use. Thereby, especially type-of-day- or time-of day-related speed variations can be taken into consideration in determining the estimated times of arrival.

The present invention relates to a method for determining the estimated time of travel and time of arrival in the route determination on a digital road map according to the preamble of claim 1. Moreover, the present invention relates to a corresponding computer program product and to a digital storage medium as well as to a navigation device.

Methods and navigation devices of the generic type for determining the estimated time of travel and time of arrival are known from the state of the art. In electronic road maps known from the state of the art, inter alia a specific classification of the average speed and the type (relevance) of the road is typically stored for each road and for each road element, which is in turn relevant for calculating the time of arrival.

Known navigation devices usually calculate the time of arrival from the average speed per road segment calculated and provided by the map maker. The average values thereby relied upon are determined by a driver or, in the best-case scenario, by several but only few drivers who are referred to as field collectors. Naturally, said drivers are job-related frequent drivers and thus exhibit a driving behavior that differs from that of for instance normal users or infrequent drivers. This gives rise to mistakes, since different drivers respectively exhibit different driving behaviors and the time of arrival thusly differs as well. Moreover, a difference is for instance likewise discernible between individual regions, such as in areas of high population density and in rural areas, which aspect cannot be represented by the conventional method.

Moreover, another drawback of any such approaches known from the state of the art resides in the thereby only static calculation of the time of arrival due to the average speeds predefined by the map maker. Consequently, the calculation of the time of arrival is not adapted to the respective user of a navigation system, in particular likewise regardless of the aspect of whether such a user travels at daytime or at nighttime, at a normal speed or in rush-hour traffic. Even if a user travels at a slower speed on certain days a navigation method or navigation device according to this known state of the art will not respond accordingly.

From document EP 1 172 631 a method is known wherein average speeds are collected for the user individually per street category and are subsequently used in the route calculation.

In the method according to said document, however, user data are only collected on the basis of the road category. Any potential differences, for instance in terms of type-of-day- or time-of-day-related speed variations, are disregarded, thus giving once again rise to inaccuracies in the calculation of the time of arrival.

Besides, according to said known teaching, in the used road maps a differentiation between identical speed classes on different road categories is not made either. Hence, it is not taken into consideration that freeways of a specific speed class are traveled along at potentially greater average speeds than highways of the identical speed class. Moreover, a differentiation is not made for instance between varying constructional conditions (single-lane, multi-lane, in-town, out-of-town etc.) in a road category, for instance in the road category “National Highway”, either.

Against this backdrop, it is hence an object of the present invention to provide a method and a device for determining the estimated time of travel and time of arrival by means of which the drawbacks residing in the state of the art can be overcome. In particular, the present invention is supposed to automatically take into consideration the user-specific driving behavior and constantly changing conditions, such as in-town travels or out-of-town travels, in determining the estimated time of travel and time of arrival in order to thusly enable the determination of the respective time of arrival of the individual user in a specific fashion with a gradually increasing degree of accuracy. Thereby, by means of the navigation method and the navigation device especially type-of-day- and time-of-day-related variations as well as further road segment attributes in terms of the determined estimated average speeds are equally supposed to be taken into consideration.

This object is attained by a method according to claim 1. The inventive solution further encompasses a computer program product according to claim 22, a digital computer-readable storage medium according to claim 23 as well as a navigation device according to claim 24.

Preferred embodiments of the present invention will be the object of the subclaims.

The method for determining the estimated time of travel and time of arrival on a digital road map according to the present invention is performed by means of a navigation device with a position determining unit, a speed determining unit, a processor unit, a mass storage unit and an input/output device in a manner basically known per se. In particular, the position determining unit and the speed determining unit can thereby for instance be realized in the form of an integrated GPS sensor.

In this context, the road network of the digital road map is classified into road sections, each road section being allocated at least one road category and each road category being allocated a corresponding average speed in a speed table. In addition, the estimated time of travel of a distance or a route is calculated from the lengths and the average speeds of the road sections of the route, wherein user speeds measured by the speed determining unit can additionally be included into the speed table.

According to the present invention, the method is characterized by the feature that the speed table is classified into temporal classes for at least one, preferably for each, road category of the road map, wherein one temporal class is respectively allocated separate, where appropriate different, average speeds as a function of the weekday and/or the time of day.

The term “road category” can thereby refer to different hierarchical and functional attributes and to the corresponding classifications of the road segments included in the road map into road segment classes, i.e. initially for instance to different road categories, such as freeways, national highways, regional highways etc.

In the context of the present invention, the term “road category” is, however, supposed to be understood in a broad sense. In particular, the term “road category” in the context of the present invention is in principle supposed to refer to arbitrary attributes or attribute combinations that can be allocated to a class of road segments, i.e. by means of which a certain set of road segments that exhibit certain common features can thusly be characterized in the road map and can be differentiated from other sets of road segments that exhibit different features.

In this way, a road category could for instance also be formed by a parameter combination of a hierarchical and functional classification of road segments and of a speed class of the corresponding road segments. In the context of the present invention, for instance a certain road category could encompass all freeway road segments of the road map that at the same time likewise exhibit a building site attribute and thusly a specific speed class.

In other words, the term “road category” in the context of the present invention is supposed to refer to any possible road segment attribute for differentiating between certain sets of road segments and equally to any combination of any such differentiating attributes by means of which the road segments included in the road map can be characterized and can thusly be classified into certain sets of road segments and road segment classes. Except for the classification as a freeway, national highway, regional highway etc., the classification into different speed classes, the allocation of building site attributes etc., the term “road category” in the context of the present invention can thereby for instance also refer to a so-called “name route type” which takes into consideration the designation of road segments according to numbered elements and can equally refer to a combination of the afore-mentioned or other functional or hierarchical attributes that can be allocated to the road elements.

By means of the present invention, each road category (and generally, each reasonable combination of possible road segment attributes) can thusly be allocated specific time-dependent average speeds in the form of different factory-preset temporal classes that can assume different values, in particular as a function of the respective weekday and/or the respective time of day. In this respect, it is possible to take into consideration that the average speeds to be expected when traveling along the corresponding road sections and road segments of the road map are not only dependent upon the respective road category but are in particular also dependent upon the different weekdays and/or times of day and for instance upon the traffic conditions to be thereby expected.

Consequently, by means of the present invention the different average speeds to be expected on different weekdays (for instance working days in contrast to weekends) or at different times of day (for instance rush-hour-traffic in contrast to leisure traffic) can be taken into consideration in the speed table that forms the basis for calculating the time of arrival.

Besides, in this context it is advantageous that the user speeds that have likewise been measured and that can be included into the speed table can also be used even in the ongoing navigation operation and can be evaluated. The user speeds are hence not required to be separately centrally collected but rather are determined, taken into consideration and stored directly on the navigation device. The driving behavior of each individual user can thusly be dynamically taken into consideration in the respective determination of the estimated time of travel.

In this regard, the speed table is additionally classified into different speed categories, preferably for at least one, particularly preferably for each road category, wherein one speed class in a road category can be respectively allocated separate, where appropriate different, average speeds. In this way, classifications into different speed classes can also be performed in one road category (as a function of other attributes, such as constructional condition, building sites, speed limits etc.), in which respectively different average speeds of the user of a navigation system are to be expected and can accordingly be included into the speed table. By means of this measure, for instance national highways can be treated differently, for instance depending upon the aspect of whether the same run in-town or out-of-town, of whether the same are constructed as single-lane or multi-lane roads etc.

Preferably, different road categories (e.g. freeway, national highway, regional highway) with respectively identical speed class are respectively allocated separate, where appropriate different, average speeds. In this way, it can be taken into consideration that for instance on a national highway with a specific attribute (such as constructional condition, building site, speed limit etc.) and thereby potentially belonging to a speed class that is formally identical with that of a freeway with identical attributes, a different (for instance lower) average speed will nevertheless be expected compared to the corresponding freeway.

In this context, it should be noted that additional attributes for road categories and road element classes, such as a building site attribute or a speed class, as already discussed above, can alternatively also be a part of the road category as such according to the definition of said term in the context of the present invention. In other words, the term “road category” in the context of the present invention is not confined to the classification of the road elements included in the road map into road element classes, such as freeways, national highways, regional highways etc., but can for instance equally refer to classes of road elements with a common speed class with the same building site attribute or with any other possible road class attribute as well as to any arbitrary combinations of such road class attributes. Specifically, according to an embodiment of the present invention provision can also be made for that a certain road category is predefined both by a specific road element class and by a specific speed class.

According to another preferred embodiment of the present invention, provision is made for that the speed table is classified into geographic classes or demographic classes for at least one, preferably for each, road category, wherein one geographic class or demographic class is respectively allocated separate, where appropriate different, average speeds as a function of a geographic or demographic regional feature. Such geographic or demographic regional features can for instance refer to the indication of whether the considered location features a rural or urban regional structure, which community sizes or demographic structures prevail, or in which country, federal state or in which state the considered region is located.

In this way, the calculation of the time of arrival can be performed even more accurately by making it possible that different average speeds to be expected can be specifically taken into consideration also as a function of such geographic or demographic regional features.

According to another preferred embodiment of the present invention, provision is made for that the speed table is classified into vehicle classes for at least one, preferably for each, road category, wherein one vehicle class is respectively allocated separate, where appropriate different, average speeds as a function of a vehicle type (for instance automobile, motorbike, truck, bicycle, pedestrian etc.). In this way, the average speeds to be expected that vary as a function of the selected means of transport and type of vehicle can be taken into consideration, in particular also in a specifically different manner for each road category. Thus, the average speed to be expected of a motorbike on the highway will potentially by greater than that of an automobile, whereas the same relation can be reversed in case of a freeway.

According to another preferred embodiment of the present invention, provision is made for that the speed table is classified into driver type classes for at least one, preferably for each road category, wherein one driver type class is respectively allocated separate, where appropriate different, average speeds as a function of a driver type (for instance age, gender, profession etc.). In this way, the average speeds to be expected that vary as a function of the driver type can be taken into consideration as well, in particular in a specifically different manner for each road category.

According to another preferred embodiment of the present invention, provision is made for that standard values are stored in a speed table (for instance ex factory) for the average speeds included therein. Thereby, the standard values for the average speeds remain valid for the calculation of the estimated time of arrival until a predeterminable number of measured user speeds has been collected by the navigation device for the respective attribute combination and class (e.g. road element class, temporal class, vehicle class etc.). This means that the actually measured user speeds are included into the relevant fields of the speed table and are thusly taken into consideration in the calculation of the time of arrival only if a reliable data basis in the form of a definable minimum number of measurements by the navigation device has been collected in the relevant fields of the speed table.

According to another preferred embodiment of the present invention, the inclusion of the measured user speeds into a speed table is performed in such a manner that the measured user speeds are respectively allocated a weighting factor and are computed based on an average speed previously included in the speed table in the relevant field to form a new average speed. Thereby, for instance the newly measured user speed to be included into the speed table can be allocated a small (where appropriate a significantly smaller) weighting factor compared to that of the average speed previously included in the speed table in the corresponding field. In this way, the average speeds already included in the table are thusly only gradually changed by means of the newly measured user speeds, whereby in particular the effect of outlier values is attenuated.

Preferably, the new average speed is determined by means of forming a moving average of several speed values. Moving averages reduce variations included in a stream of data and thusly result in an (adjustable) smoothening of the determined speed values, likewise resulting in an enhanced stabilization and a more uniform adaptation of the average speeds included in the speed table to the measured user speeds.

Likewise for the purpose of stabilizing the average speeds included in the speed table as well as for the purpose of an increased plausibility and reliability of said average speeds, another embodiment of the present invention is characterized by the feature that the measured user speeds lying beyond a predeterminable extreme value interval that can be defined particularly on the basis of the road category (or generally on the basis of the class) are ignored in forming a new average speed for the speed table. In this way, the effect of implausible or flawed measured values or the effect of outlier values is attenuated as well.

According to another preferred embodiment of the present invention, the temporal class formed in the speed table for at least one, preferably for each, road category extends over several time intervals included in the temporal class. The time intervals can for instance respectively be hourly periods, in which case one temporal class can in particular encompass for instance respectively a period of several hours. Additionally or alternatively, temporal classes can likewise be formed in terms of weekdays. In particular, one temporal class can thereby equally encompass non-adjacent time intervals.

Preferably, different temporal classes respectively cover time intervals of different lengths, in particular as a function of the weekday or the time of day. By means of this aspect it is possible to take into consideration that certain traffic situations (such as rush-hour traffic) specifically occur at a certain time of day and have a comparatively short duration, whereas other traffic situations (such as leisure or holiday traffic) specifically occur at other times of day or on other weekdays and can for instance have a longer duration.

Particularly preferably, an average value of the average speeds included in this temporal class is formed over the time intervals of the temporal class for which a certain determinable number of measured user speeds has not yet been exceeded, and said average is used in the relevant temporal class for determining the estimated time of arrival. Equally, preferably for the time intervals of a temporal class for which a certain number of measured user speeds has already been exceeded, the average speed stored for said time interval is individually taken into consideration and is taken as a basis in the concerned time intervals for determining the estimated time of arrival.

Thus, it is initially possible to take into consideration an average value in a temporal class of the user speeds included in the individual time intervals of the temporal class until at least in individual time intervals of the temporal class a definable minimum number of measured user speeds has been exceeded. Subsequently, in the time intervals in which the definable minimum number of measured speeds is exceeded, said user speeds can be taken into consideration individually, whereas the remainder of the temporal class is still taken into consideration in terms of an average value (that can for instance be predetermined by the manufacturer).

According to another preferred embodiment of the present invention, provision is made for that a final check is performed by determining the actual total time taken from the start to the destination of the corresponding routing operation after having passed a route. Subsequently, by means of adapting the actual total time to the total time determined by means of the speed table, an adaptation, and, where appropriate, a corresponding correction, of the concerned average speeds included in the speed table can be performed.

According to another preferred embodiment of the present invention, a speed table stored in the navigation device or at least partially created by the navigation device is transmitted to a central server. Preferably, from the speed tables transmitted by different navigation devices to the server comprehensive speed profiles are thereby generated as possible future factory settings for navigation devices.

According to another embodiment of the present invention, a speed profile accordingly generated from the speed tables of different navigation devices or of different users is transmitted from the server to a navigation device.

By means of this embodiment, it is consequently possible to constantly improve the speed profiles that are stored ex factory or by the server by taking into consideration the speed tables transmitted to the server by numerous users or navigation devices, and the speed profiles improved in this way can subsequently, where appropriate, be returned to the navigation devices of numerous users and can be used there for enhancing the accuracy of the predicted time of arrival.

According to another embodiment of the present invention, it can be taken into consideration in transmitting a server-provided speed profile to a navigation device of a user that average speeds included in the speed table of the navigation device are overwritten with values provided by the server only if the relevant road categories, temporal classes, vehicle classes etc. exhibit less than a predeterminable number of already collected speeds of the relevant user.

The differentiation between average speeds provided ex factory and by the server and average speeds determined by the user according to another preferred embodiment of the present invention is performed by storing in the navigation device at least two speed tables. Thereby, a first speed table contains the speed data provided by the server and predefined ex factory and a further speed table contains the speed data collected by the user. The first speed table is thereby accessed if and for as long as the relevant fields of the further speed table exhibit less than a predeterminable number of collected user speeds. Otherwise, as soon as a sufficient number of user speeds has been collected, the further speed table is subsequently accessed in which the average speeds determined by the user are stored.

Moreover, the present invention relates to a computer program product assigned to the inventive method, a corresponding digital storage medium and an equally inventive navigation device. Thereby, the inventive computer program product comprises program steps stored on a machine-readable carrier for performing the above described inventive method if the same are implemented by a programmable processor unit. The digital storage medium according to the present invention contains electronically readable control signals which are capable of interacting with the processor unit subsequent to the readout by a programmable processor unit in such a manner that the described inventive method is performed by the processor unit.

The inventive navigation device ultimately serves for determining the estimated time of travel and time of arrival in the route determination on a digital road map and comprises a position determining unit, a speed determining unit, a processor unit, a mass storage unit and an input/output device. The digital road map thereby comprises a road network classified into road sections, each road section being allocated at least one corresponding road category and each road category being allocated an average speed in a speed table. In this respect, the estimated time of travel of a route can be calculated from the lengths and the average speeds of the road sections of the route, wherein measured user speeds can be additionally included into the speed table. The processor unit of the navigation device is installed for implementing the above described computer program product, for reading the mentioned digital storage medium or for performing the above described inventive method.

In the following, the present invention will be described in greater detail with reference to the drawings illustrating only exemplary embodiments.

In the drawings:

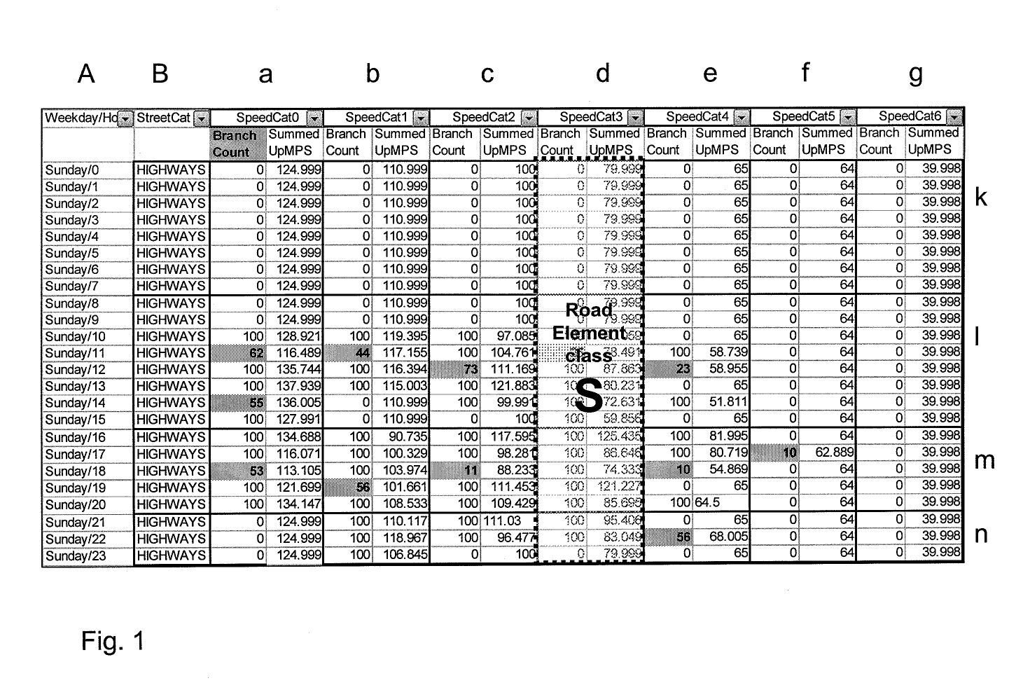

FIG. 1 illustrates a cut-out from a speed table according to an embodiment of the inventive method;

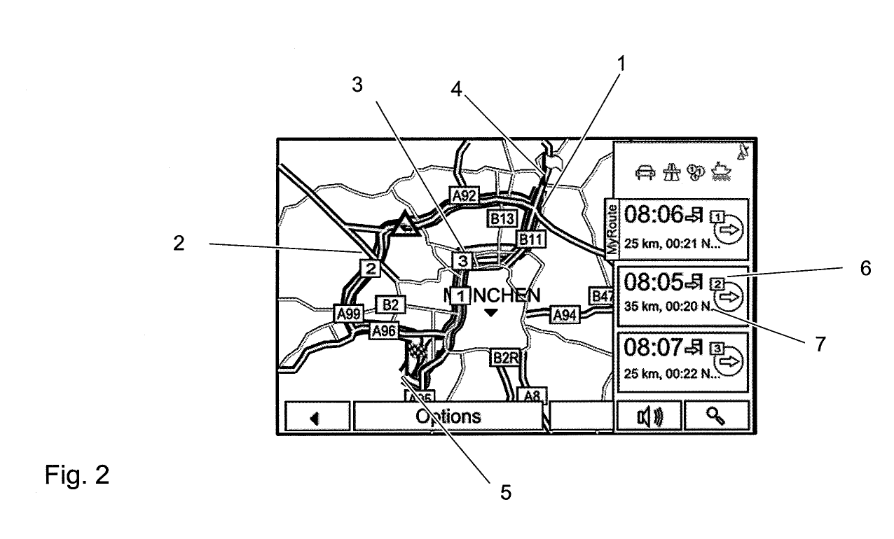

FIG. 2 illustrates a cut-out from a monitor representation of a navigation device during morning rush-hour traffic; and

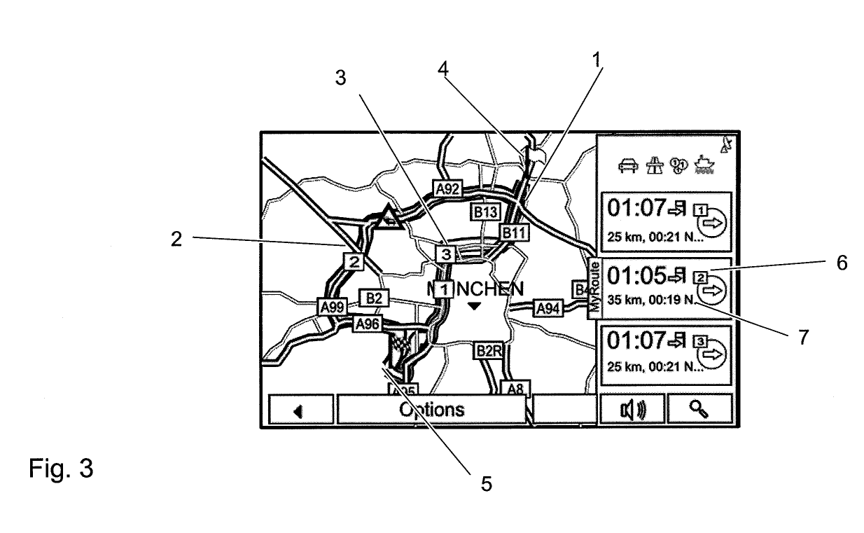

FIG. 3 in an illustration corresponding to FIG. 2 illustrates the relevant cut-out from the monitor representation according to FIG. 2 during a nighttime drive.

FIG. 1 illustrates a cut-out from a speed table stored in an inventive navigation device.

Therein, Sunday is exemplarily illustrated in column A with the road category “Highway” in column B. This means that the speed table of the navigation device comprises at least for each day A and for each road category B a table region that corresponds to the illustrated table region.

Besides, various speed classes a to g are horizontally indicated, such that the value fields of the table in columns a to g respectively exhibit speed average values and the respectively corresponding number of the user values already measured by the navigation device.

In order to include user speeds into the speed table, measurements of the current speed are performed at predeterminable intervals when the vehicle is traveling along a route, whereby an active routing operation is not necessarily required.

To this end, the road elements respectively included in the road map are processed by reading the current road element from the map database by means of the position determining unit via map matching and by determining the matching road element class (for instance road element class S) by taking into consideration specific attributes (here road category B and speed classes a, b, c, d, e, f, g). In addition, the current day and the current time of day are determined for instance via GPS by means of which the matching temporal class k, l, m, n and the matching time interval (time of day) are identified and the respectively determined user speeds are included into the corresponding table fields (in “SummedUpMPS”).

In order to enhance the quality of the collected data and to compensate for flaws in the position determination (e.g. via GPS), a plausibility check can thereby be performed in such a manner that the determined average speeds that lie below a minimum value (e.g. 10 km/h) and that lie above a maximum value (e.g. 250 km/h) are not used for the data collection. In case of potentially equally available speed profiles and corresponding speed tables, such as “bicycle” or “pedestrian”, in particular other threshold values can thereby be defined in order to prevent a distortion of the corresponding database by a subsequent accidental use of the profile “automobile”.

Due to potentially different driving behaviors in different countries it can also be advantageous to differentiate between individual countries as well as to respond to regional conditions and to respectively treat the same separately and to store the same in separate tables.

Besides, in practice differentiations can also be made between big and small towns. Thus, it is for instance revealed that the traffic flow in Milan is slowed by an approx. 15 km/h in contrast to Würzburg. This aspect can be rendered apparent by means of specific road element attributes, by means of the speeds and by means of the road map and can accordingly be taken into consideration in the data collection.

In particular, to this end determined speed profiles can be collected on a central server and can be classified into an arbitrary number of classes by conventional classification methods. Said classes can subsequently be taken as a basis for future factory settings and can for this purpose for instance be transmitted in a wireless or wire-bound way to navigation systems of users. Such a central collection of determined speed profiles may for instance reveal that drivers from England travel at an average of 10 km/h slower than drivers from Germany. As a consequence, the provided standard profile for devices in England would be based on average speeds reduced by 10 km/h.

If such a speed table is loaded from a central server, it is necessary to decide whether all of the values collected by the user himself/herself are hereby supposed to be overwritten or whether individual measurements are supposed to be retained. The second alternative is advantageous in case of intensive use. For this reason, in the speed table according to FIG. 1 for each entry in the field “Branch Count” a differentiation is made in terms of whether a predeterminable number of measurements by the user is already present or not present. In the latter case, the updated values from the centrally provided speed table are adopted, whereas in the first case, the values collected by the user are retained.

Besides, for the purpose of a plausibility check, a final check of the travels and hence of all the collected data is performed by determining the time of the travel from the start to the destination is determined and comparing it with the collected data in order to thusly adapt the stored speeds. The basic principles underlying the plausibility check and the adaptation are thereby derived from the feedback control system.

As a function of the selected vehicle type (for instance motorbike or truck) the system additionally generates, where appropriate, different speed profiles that are preferably reserved for and stored in different speed tables.

It is also apparent from FIG. 1 that temporal classes k, l, m, n are respectively formed in the speed table, which as a function of the speed classes a to g form blocks in which uniform average speeds are valid if a respectively determinable minimum number of measured average speeds has not been collected yet in the time intervals of the respective block (here hours). Since in this case, different speed time variation curves are usually generated for different days, it is advantageous to differentiate temporal classes also in terms of days or types of day. In this respect, in case of Friday, Saturday and Sunday, and likewise among these days, different time variation curves may be expected than in case of Monday to Thursday. Consequently, it is expedient to separately manage the average speeds per road category for each day or for each type of day. Public holidays can thereby be treated in the same way as Sundays.

In this way, in the speed table of the road category “Highway” illustrated in FIG. 1 several (in the illustrated exemplary situation 7) speed classes a, b, c, d, e, f, g are thusly formed, whereby in the present situation, the road element classes (for instance road element class S) are thusly initially defined. The accordingly formed road element classes in the illustrated example are ultimately additionally classified into temporal classes k, l, m, n which in turn comprise several time intervals (here hourly periods).

Thereby, for instance the two table blocks for 0-8 h and for 21-0 h that are defined by the temporal classes k and n from 0-8 h and from 21-0 h in speed class a currently respectively additionally contain an empirically determined average speed of almost 125 km/h for the speed class SpeedCategory0 (determined by the map maker) in the corresponding column a.

If the user has for instance not yet frequently traveled on Sunday at 1 h at night and if the required number of measured values of (in the exemplary case) 100 is consequently neither collected in the fields of the table block of the corresponding temporal class n of 21-0 h nor in the corresponding speed class SpeedCategory0 in column a, the average speed entered ex factory into the corresponding table block of almost 125 km/h is subsequently used in order to calculate the estimated time of arrival of the user under these prevailing ancillary conditions.

By contrast, in temporal class 1 (interval of 8-16 h) for the speed class SpeedCategory0 in column a, a certain number of measured values has already been collected as a result of the travels previously completed by the user. In the time interval 11 h of the temporal class 1 (8-16 h), a measured value quantity of 62 detected data sets with a corresponding average speed of 116.5 km/h has been collected. In the situation at hand, an average speed in a one-hour time interval of a temporal class k, l, m, n is, however, only independently valid when a measured value quantity of 100 is reached. For this reason, in temporal class 1 from 8-16 h of speed class SpeedCategory0 in column a, an average is initially formed from all of the collected speed values of the relevant table block. This speed average is subsequently used in the concerned table block in the temporal class 11 h for determining the time of arrival.

Similar steps are performed in all temporal classes in the absence of an independently valid measured value quantity, i.e. in case of measured value quantities from 0-99. Measured value quantities that lie above 100 are not separately recorded, but speed values additionally collected in further speed measurements are, however, used to accordingly adapt the respective average speeds in the corresponding table fields.

Hence, in the speed class Speed Category 01 in column b a sufficient number of measured speeds has already been collected in each of the hourly time intervals in temporal class n (21-0 h), such that in each of said hours the average speed respectively entered into the table and formed by taking into consideration the measured speeds can be independently used for calculating the estimated time of arrival in the respective hourly time interval.

The taking into consideration of the measured value quantities and the inclusion of the measured corresponding speeds is hence constantly performed during the travel. As a function of the determination of the road category B and the speed classes a-g by the map maker, for instance a freeway (in Germany classified as the road category “Highway”) with a predetermined length and as a function of additional attributes, such as the number of exit roads, constructional condition, presence of building sites etc., is classified into a speed class a-g. In the exemplary case of a freeway (road category B=Highway) with SpeedCategory3, such a classification can for instance be based on a building site with the speed limit set at 80 km/h.

If for a table field, for instance Highway, with speed class b (SpeedCategory1), temporal class m and with the time interval Sunday between 16 and 17 h, an average speed based on a sufficiently large number of measured speeds is available (as is apparent in FIG. 1, in this situation at least 100 measurements have been collected, from which an average speed of 90.735 km/h has been formed), in the illustrated exemplary embodiment further measured user speeds for said road class on this day and at this time are thus taken into consideration and are included into the table, as is described in the following:

If the user thusly travels along a freeway with SpeedCategory1 at a constant speed of 100 km/h on a Sunday between 16 and 17 h, each accordingly obtained measured value (for instance per time unit and/or per road segment) is allocated a weighting factor and is computed based on the average value already included in the table. In the illustrated exemplary embodiment this is performed by using the following formula for forming the new average speed Dnew from the previously valid average speed of 90.735 km/h and the newly measured user speed of 100 km/h:

Dnew=(90.735 km/h*100+100 km/h)/(100+1)=90.827 km/h

In other words, in forming the new average speed for inclusion into the speed table, in the situation at hand the previously valid speed value of 90.735 km/h is allocated a weighting factor that is 100 times the weight of the new speed value of 100 km/h.

In this way, with the ongoing time of travel and the ongoing accumulation of newly measured speeds, the current user speed is gradually approximated. Thus, the new average speed entered into the speed table for the concerned road element class and time of day subsequent to e.g. 20 further measurements and iterations at a constantly measured 100 km/h is already set at 92.407 km/h.

Subsequently in each route calculation, i.e. in a rerouting operation due to a road blocking or due to a TCM event, the accordingly calculated data are included into the calculation of the estimated time of arrival.

On the basis of the values thusly collected in the speed table it is ultimately equally possible to calculate a route, whereby the time of arrival thereof is determined as a function of the data collected in the speed table. For this purpose, it is initially necessary to select from the speed table the corresponding average speed value stored therein for each road element of the calculated route to be traveled.

In the light of the fact that per road element class S several, in particular day-dependent, temporal classes are present in the speed table, for which a respectively different average speed can be available, it is hereby necessary to initially determine for each road element in an iterative fashion the time of day at which the concerned road element will presumably be reached on the basis of the currently predicted average speeds of the road elements to be passed, temporally speaking, prior to the concerned road element. Subsequent to the determination of the estimated time of arrival at said road element, it is consequently possible to use the average speed stored for this time of day.

The example illustrated in FIG. 1 is thereby used as a reference table for the respective user. Any such reference table is thusly preferably available for each weekday and for all of the four road categories, i.e. Highway, National, Country and Minor. In the illustrated situation, the profile only applies to a car driver. It is equally possible that reference profiles for truck, motorbike, pedestrian and bicyclist are available.

In the following, by means of a concrete example, the successive adaptation of the average speeds stored in the speed table and thusly of the prospectively calculated estimated times of travel to the actually measured user speeds will be described. According to this example, the calculated time of arrival is successively adapted to the driver's driving behavior. If the driver always drives at a high speed, the predicted time of travel for a corresponding route will in the course of time become gradually shorter than in the case of a driver who travels at a low speed.

A driver F for instance travels with his family from a village D on a Sunday afternoon to the zoo in city G that is 20 km away. The driver F is thereby given sufficient time and travels at a leisurely speed, however, in the absence of retarding congestions and in the absence of increased traffic volume. In this situation, a time of travel of 25 minutes from D to G is calculated.

The time of travel to the destination calculated by the navigation device by means of the average speeds previously entered into the speed table in the present situation was, however, only 20 minutes. This results in a difference of +5 minutes in contrast to the actual time of travel. On the basis of said time difference of +5 minutes, the system calculates an adaptation of the used average speeds in the speed table after arrival at the destination, such that for the same route at a similar time of day an estimated time of travel will be prospectively calculated, which (depending upon the manner of forming the current average value) will be longer for instance by +1 minute. The concrete forming of the new average speed thereby depends upon a large variety of factors, especially upon the data already collected beforehand and upon the respectively used calculation formula, also see the above exemplary formula.

On the subsequent Monday, the navigation device calculates an estimated time of travel of 35 minutes for the same length of route with the same start in D and for a similar destination in the same city G. In the light of the aspect that in this travel the driver F gets, however, stuck in a traffic jam, he does in fact require 40 minutes to complete this travel. As described above in the case of the Sunday travel, also in this situation an adaptation of the average speeds stored in the table is once again performed upon completion of the travel in terms of increasing the estimated time of arrival to be prospectively determined, for instance by +40 seconds.

On the same Monday, the driver F travels back home in the evening in the absence of any significant traffic volume and, since he is in a hurry, the driver additionally travels from G to D in only 20 minutes instead of the estimated 35 minutes calculated by the navigation device. Accordingly, another adaptation of the average speed is performed in the speed table, such that in the subsequent calculation of the estimated time of travel (on the same weekday and at a similar time of day) an estimated time of travel shortened by −3 minutes will be calculated.

In this way, the actually traveled user speeds are hence constantly taken into consideration as a function of the weekday, the time of day, the road category and, where appropriate, of other attributes and parameters and the correspondingly measured values are accordingly successively included into the speed table of the navigation device. In this way, the respectively calculated estimated time of travel gradually adapts with a gradually increasing degree of accuracy to the actual behavior of the respective user in the past.

If the measurements collected in the speed table reveal that a driver travels on specific road categories or road element classes at a particularly low or particularly high speed, these categories may optionally be additionally disregarded or prioritized in the route calculation.

FIGS. 2 and 3 respectively illustrate a cut-out from the monitor representation of a navigation device during morning rush-hour traffic (FIG. 2) and during a nighttime drive (FIG. 3). Thereby, in particular the effect of the estimated time of arrival determined by the navigation device as a function of the time of day is rendered apparent.

In the example, a navigation device is illustrated that determines for the user several routes 1, 2, 3 between starting point 4 and destination 5. In FIG. 2, the calculation is performed for the morning of a working day, whereas in FIG. 3, the calculation is performed for the night likewise of a working day.

In case of freeways on which the route 2 runs, the estimated average speeds stored in the speed table are greater with respect to nighttime hours than with respect to morning hours. In case of the expected time of arrival 6 and the estimated time of travel 7 this difference is rendered apparent. For this reason, according to FIG. 3, it is recommended to travel along the freeway (route 2) at night, whereas according to FIG. 2, it is recommended to travel along route 1 in the morning. Even though, according to FIG. 2, the estimated time of travel along route 2 is in fact estimated to be somewhat shorter than the time of travel along route 1, route 1 is nevertheless recommended, since in the underlying embodiment the net length of the route is additionally taken into consideration, which in the case of route 1 is significantly shorter than in the case of route 2.

1. Navigation method for determining the estimated time of travel and time of arrival in the route determination on a digital road map by means of a navigation device comprising:
a) providing a navigation system including a position determining unit, a speed determining unit, a processor unit, a mass storage unit and an input/output device;
b) classifying a road network of the digital road map into road sections, each road section being allocated at least one corresponding road category and each road category being allocated an average speed in a speed table, wherein the estimated time of travel of a route is calculated from the lengths and from the average speeds, stored in the table, of the road sections of the route, and wherein the user speeds calculated by the speed determining unit can additionally be included into the speed table; and
c) classifying the speed table into temporal classes for at least one road category, wherein one temporal class is respectively allocated separate average speeds as a function of the weekday and/or the time of day.

2. The navigation method according to claim 1, wherein the speed table is classified into different speed classes for at least one road category, wherein one speed class is respectively allocated separate average speeds, in particular that different road categories with identical speed class are respectively assigned separate average speeds.

3. The navigation method according to claim 1, wherein the speed table is classified into geographic classes or demographic classes for at least one road category, wherein one geographic class or demographic class is respectively allocated separate average speeds as a function of a geographic or demographic regional feature, and/or that the speed table is classified into vehicle classes for at least one road category, wherein one vehicle class is respectively allocated separate average speeds as a function of a vehicle type, and/or that the speed table is classified into driver type classes for at least one road category, wherein one driver type class is respectively allocated separate average speeds as a function of a driver type.

4. The navigation method according to claim 1, wherein standard values are stored for the average speeds in a speed table and remain valid until a predeterminable number of measured user speeds has been collected in the respective class.

5. The navigation method according to claim 4, wherein the measured user speeds are allocated a weighting factor and are computed based on an average speed included in the speed table to form a new average speed and are included into a speed table, in particular that a moving average of speed values is taken into consideration in determining the current average speed.

6. The navigation method according to claim 4, wherein the measured user speeds that lie outside a predetermined extreme value interval being defined especially as a function of the road category are disregarded in the calculation of a new average speed.

7. The navigation method according to claim 5, wherein the measured user speeds that lie outside a predetermined extreme value interval being defined especially as a function of the road category are disregarded in the calculation of a new average speed.

8. The navigation method according to claim 1, wherein at least one temporal class exhibits several time intervals.

9. The navigation method according to claim 8, wherein at least one temporal class comprises temporally non-adjacent time intervals, and different temporal classes cover time intervals of different lengths as a function of the weekday or the time of day.

10. The navigation method according to claim 9, wherein for a time interval of a temporal class for which a certain number of measured user speeds is not exceeded, an average value of the average speeds respectively included in the temporal class is formed and is taken as a basis for determining the estimated time of arrival, and/or that for a time interval of a temporal class for which a certain number of measured user speeds is exceeded, the average speed stored for this time interval is taken into consideration and is taken as a basis for determining the estimated time of arrival.

11. The navigation method according to claim 1, wherein a final check is performed by analyzing the total time taken from the start to the destination of a routing operation and the average speeds in the speed table are corrected by using the result obtained.

12. The navigation method according to claim 1, wherein one or more speed table stored in the navigation device or created by the navigation device are transmitted to a central server.

13. The navigation method according to claim 12, wherein comprehensive speed profiles are generated as future factory settings from the speed tables transmitted to the server by different navigation devices.

14. The navigation method according to claim 12, wherein a speed profile generated from the speed tables of different navigation devices is transmitted from the server to a navigation device.

15. The navigation method according to claim 14, wherein in transmitting a speed profile from the server to a navigation device, the average speeds in the speed table of the navigation device are overwritten with values from the server speed profile only if the corresponding table regions exhibit less than a predeterminable number of collected user speeds.

16. The navigation method according to claim 12 wherein at least two speed tables are stored in the navigation device, wherein a first speed table includes factory-predefined speed data and a further speed table additionally includes speed data collected by the user, wherein the first speed table is accessed if the corresponding region of the further speed table exhibits less than a predeterminable number of collected user speeds, and wherein otherwise the further speed table is accessed.

17. The navigation method according to claim 16 wherein at least two speed tables are stored in the navigation device, wherein a first speed table includes factory-predefined speed data and a further speed table additionally includes speed data collected by the user, wherein the first speed table is accessed if the corresponding region of the further speed table exhibits less than a predeterminable number of collected user speeds, and wherein otherwise the further speed table is accessed.
